(19) United States
(12) Patent Application Publication
(10) Pub. No.: US 2006/0001894 A1
(43) Pub. Date: Jan. 5, 2006

(54) Image processing with threshold matrices

(75) Inventor: Yukimitsu Fujimori, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/167,586

(22) Filed: Jun. 28, 2005

(30) Foreign Application Priority Data
Jun. 29, 2004 (JP) 2004-190945

(51) Int. Cl. G06F 15/00

(52) U.S. Cl. 358/1.13

(57) ABSTRACT

An image processing device of the invention processes images with threshold matrices in either of two available print modes, that is, a first print mode and a second print mode. When a combination of the printing resolutions of the second print mode in the main scanning direction and in the sub-scanning direction is identical with an interchanged combination of the printing resolutions of the first print mode in the main scanning direction and in the sub-scanning direction, a threshold matrix for the first print mode is rotated by 90 degrees to set a threshold matrix for the second print mode. When the printing resolutions of the second print mode in the main scanning direction and in the sub-scanning direction are respectively n times (where n denotes a positive number) of the printing resolutions of the first print mode in the main scanning direction and in the sub-scanning direction, on the other hand, a threshold matrix for the second print mode is used as a threshold matrix for the first print mode. This arrangement desirably saves the memory capacity for storage of the threshold matrices.

### BACKGROUND OF THE INVENTION

1. Field of the Invention

The present invention relates to a technique of processing image data with threshold matrices to generate print data, which is supplied to a printing device that creates dots and completes a printed image.

2. Description of the Related Art

Inkjet printers in widespread use eject inks from a print head and create dots on a printing medium to complete a printed image. In general procedure, an image processing device makes object image data to be printed go through a preset series of processing and generates print data, which is to be supplied to the printer that creates dots to print an image. One typical image processing procedure processes images with threshold matrices, for example, according to the known dither method. With a recent advancement for the finer dot formation, some proposed printers have the additional function of changing over the setting of printing resolutions of a print head in the main scanning direction and in the sub-scanning direction.

Corresponding to these printers having the function of changing over the setting of the printing resolutions of the print head, the image processing device uses different threshold matrices individually prepared for the available combinations of the printing resolutions. The image processing device is thus required to have a significantly large memory capacity for storage of these threshold matrices. There are accordingly some techniques proposed to reduce the required memory capacity for storage of the threshold matrices as disclosed in, for example, Japanese Patent Laid-Open Gazettes No. 11-355571 and No. 2002-77646.

The prior art techniques disclosed in these cited references, however, still require individual preparation and storage of threshold matrices corresponding to multiple print modes having different ratios of the printing resolution in the main scanning direction to the printing resolution in the sub-scanning direction. Namely these prior art techniques can not sufficiently save the memory capacity for storage of the threshold matrices.

### SUMMARY OF THE INVENTION

The object of the invention is thus to eliminate the drawbacks of the prior art techniques and to effectively save the memory capacity for storage of threshold matrices in an image processing device that processes images with the threshold matrices.

In order to attain at least part of the above and the other related objects, the present invention is directed to a first image processing device that makes image data go through a preset series of image processing to generate processed data, which is to be supplied to a printing device that creates dots and completes a printed image. The printing device prints an image in a selected print mode between two available print modes, that is, a first print mode having a ratio of a printing resolution in a main scanning direction to a printing resolution in a sub-scanning direction equal to A to B, where A and B are mutually different natural numbers, and a second print mode having a ratio of the printing resolution in the main scanning direction to the printing resolution in the sub-scanning direction equal to B to A.

The first image processing device includes: a storage module that stores a first threshold matrix prepared for the first print mode; an image data input module that inputs object image data; a print mode setting module that sets either one of the first print mode and the second print mode in response to a user's selection; a resolution conversion module that converts an absolute resolution of the input object image data into a printing resolution corresponding to the set print mode; a threshold matrix transform module that, in response to setting of the second print mode, reads the first threshold matrix from the storage module and generates a second threshold matrix for the second print mode from the first threshold matrix; and a dot data generation module that generates dot data representing dot on-off state of respective pixels included in the resolution-converted image data, based on the resolution-converted image data and the threshold matrix corresponding to the set print mode.

The first image processing device of the invention generates the second threshold matrix for the second print mode from the first threshold matrix prepared for the first print mode. It is accordingly not required to prepare the second threshold matrix in advance. This arrangement desirably saves the memory capacity for storage of threshold matrices in the image processing device that processes images with the threshold matrices.

In the image processing device of the invention, the second threshold matrix may be generated by any of diverse methods. One applicable method rearranges respective elements of the first threshold matrix to positions rotated clockwise or counterclockwise by 90 degrees. Another applicable method sets a transposed matrix of the first threshold matrix to the second threshold matrix.

In the first image processing device of the invention, a combination of the printing resolutions of the second print mode in the main scanning direction and in the sub-scanning direction is identical with an interchanged combination of the printing resolutions of the first print mode in the main scanning direction and in the sub-scanning direction. As proved by the inventors' experimental findings, application of the second threshold matrix, which is a matrix including the elements of the first threshold matrix rearranged to the 90-degree-rotated positions or a transposed matrix of the first threshold matrix, can generate dot data without lowering the picture quality of a resulting printed image.

In the first image processing device of the invention, the second threshold matrix may be generated by diversity of procedures. Three possible procedures are given below as examples.

In the first example, the threshold matrix transform module changes a reading order of respective elements of the first threshold matrix from the storage module to generate the second threshold matrix. For example, in the first print mode, the respective elements of the first threshold matrix are read from the storage module in a preset order from the upper left to the lower right. In the second print mode, the respective elements of the first threshold matrix are read from the storage module in a different order, for example, from the lower left to the upper right. This arrangement readily rearranges the respective elements of the first threshold matrix to the 90-degree-rotated positions to generate the second threshold matrix.

In the second example, the first image processing device of the invention has a working area used for generation of the second threshold matrix. The threshold matrix transform module reads the first threshold matrix from the storage module, writes the first threshold matrix in the working area, and processes the first threshold matrix by a preset operation on the working area, so as to generate the second threshold matrix.

In the third example, the first image processing device of the invention has a working area used for generation of the second threshold matrix. The threshold matrix transform module reads the first threshold matrix from the storage module, and changes a writing order of respective elements of the first threshold matrix into the working area, so as to generate the second threshold matrix.

Any of the procedures of these examples can generate the second threshold matrix from the first threshold matrix.

The present invention is also directed to a second image processing device that makes image data go through a preset series of image processing to generate processed data, which is to be supplied to a printing device that creates dots and completes a printed image. The printing device prints an image in a selected print mode between two available print modes, that is, a first print mode having a printing resolution in a main scanning direction and a printing resolution in a sub-scanning direction respectively equal to A and B, where A and B are mutually different natural numbers, and a second print mode having the printing resolution in the main scanning direction and the printing resolution in the sub-scanning direction respectively equal to n·A and n·B, where n denotes a positive number.

The second image processing device includes: a storage module that stores a threshold matrix prepared for the second print mode; an image data input module that inputs object image data; a print mode setting module that sets either one of the first print mode and the second print mode in response to a user's selection; a resolution conversion module that converts an absolute resolution of the input object image data into a printing resolution corresponding to the set print mode; and a dot data generation module that, in response to setting of the first print mode, generates dot data representing dot on-off state of respective pixels included in the resolution-converted image data, based on the resolution-converted image data and the threshold matrix.

In the image processing device having two available print modes, that is, the first print mode having the printing resolution in the main scanning direction and the printing resolution in the sub-scanning direction respectively equal to A and B, and the second print mode having the printing resolution in the main scanning direction and the printing resolution in the sub-scanning direction respectively equal to n·A and n·B, the prior art technique generates dot data with individually prepared threshold matrices. As proved by the inventors' experimental findings, while application of the threshold matrix for the first print mode to generation of dot data in the second print mode may lower the picture quality of a resulting printed image, application of the threshold matrix for the second print mode to generation of dot data in the first print mode does not lower the picture quality of the resulting printed image.

The second image processing device of the invention applies the threshold matrix prepared for the second print mode to generation of dot data in the first print mode. It is accordingly not required to prepare the threshold matrix for the first print mode in advance. This arrangement desirably saves the memory capacity for storage of threshold matrices in the image processing device that processes images with the threshold matrices.

The image processing device of the invention is not essentially required to have all the characteristics discussed above. Part of the characteristics may be omitted or combined appropriately according to the requirements. The technique of the invention is not restricted to the arrangements of the image processing device discussed above, but is also actualized by a control method of the image processing device, computer programs to attain the functions of the image processing device and the control method, recording media in which such computer programs are recorded, data signals that include such computer programs and are embodied in carrier waves, and diversity of other adequate applications. Any of the additional arrangements discussed above may be adopted in any of these applications.

In each of the applications of the computer programs and the recording media in which the computer programs are recorded, the computer program may be constructed as a whole program for controlling the operations of the image processing device or as program codes for exerting only the essential functions of the invention. Typical examples of the recording media include flexible disks, CD-ROMs, DVD-ROMs, magneto-optical disks, IC cards, ROM cartridges, punched cards, prints with barcodes and other codes printed thereon, internal storage devices (memories, such as RAMs and ROMs) and external storage devices of the computer, and diversity of other computer readable media.

### BRIEF DESCRIPTION OF THE DRAWINGS

FIG. 1 schematically illustrates the configuration of a printing system in one embodiment of the invention;

FIG. 2 is a flowchart showing a print data generation process executed in the embodiment;

FIG. 3 is a flowchart showing the details of a mask setting process executed at step S100 in the print data generation process of FIG. 2;

FIG. 4 shows clockwise rotation of a dither mask by 90 degrees;

FIG. 5 shows interchange of row elements with column element in a dither mask;

FIGS. 6(A) through 6(C) show preparation of dither masks for Mode 4 and Mode 3 from a dither mask for Mode 5 by changing the reading order of the respective elements of the dither mask for Mode 5 from a hard disk; and

FIGS. 7(A) through 7(C) show preparation of dither masks for Mode 4 and Mode 3 from a dither mask for Mode 5 by changing the writing order of the respective elements of the dither mask for Mode 5 into a memory.

### DESCRIPTION OF THE PREFERRED EMBODIMENTS

One mode of carrying out the invention is described below as a preferred embodiment in the following sequence:
A. Printing System
B. Print Data Generation Process
C. Mask Setting Process
D. Modifications
   A. Printing System

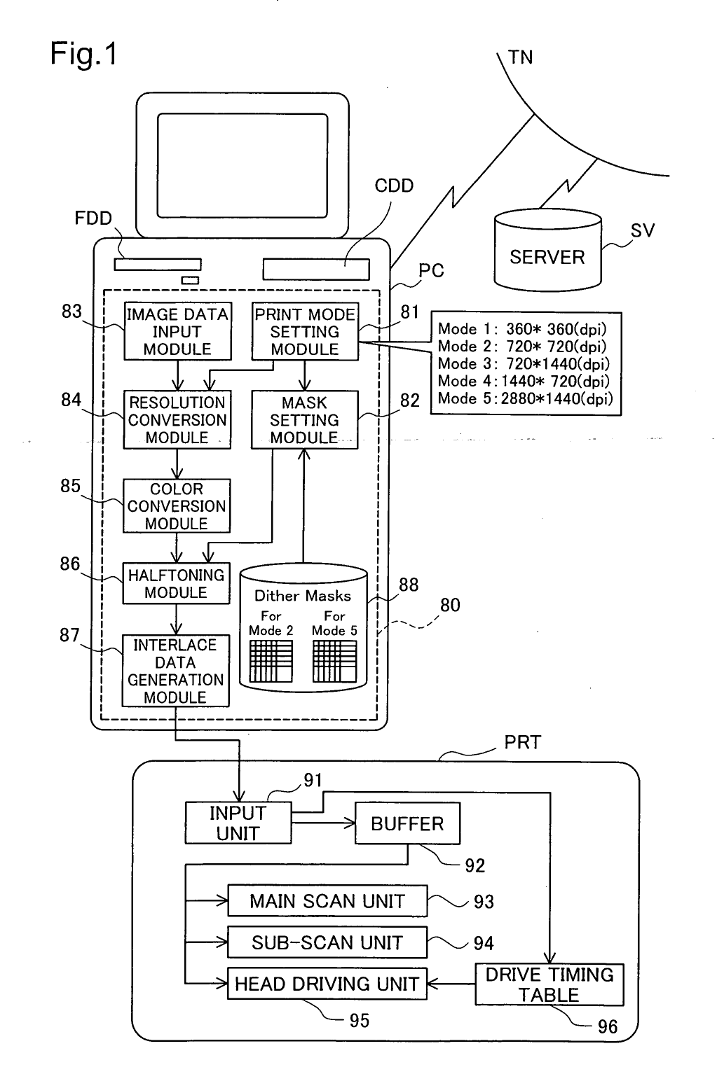

FIG. 1 schematically illustrates the configuration of a printing system in one embodiment of the invention. In the printing system, a printer PRT is connected to a computer PC and receives print data generated by a printer driver 80 incorporated in the computer PC to perform a printing operation. The print data includes raster data representing the dot on-off state of respective pixels on rasters and sub-scan feed data representing a feed amount of sub-scan. The computer PC and the raster data of this embodiment are respectively equivalent to the image processing device and the dot data of the invention.

The computer PC includes a CPU, a memory, a hard disk, and a communication device, although these elements are not specifically illustrated. The computer PC is connected to an external network TN and may have access to a selected server SV to download a required program for driving and controlling the printer PRT as well as required data. The computer PC may otherwise load the required program and data from a recording medium, such as a flexible disk set in a flexible disk drive FDD or a CD-ROM set in a CD-ROM drive CDD. The whole program required for printing may be loaded as an integral body or only the required functions may be loaded in the form of modules.

A selected application program (not shown) runs under control of a specific operating system in the computer PC. The application program is used to generate and retouch images. The printer driver 80 is incorporated in the operating system. The printer driver 80 is executed by the CPU of the computer PC and is equivalent to a program that attains the function of generating print data, which includes sub-scan feed data and raster data representing the dot recording state in each main scan.

The printer driver 80 receives image data from the application program and generates print data to be supplied to the printer PRT. The printer driver 80 includes a print mode setting module 81, a mask setting module 82, an image data input module 83, a resolution conversion module 84, a color conversion module 85, a halftoning module 86, and an interlace data generation module 87.

The print mode setting module 81 provides a graphical user interface for the user's selection of a desired print mode and sets a selected print mode in response to the user's operation of an input device (not shown), such as a keyboard and a mouse. In the structure of this embodiment, the print mode setting module 81 has five available print mode options:
(1) Mode 1: 360(dpi)×360(dpi)
(2) Mode 2: 720(dpi)×720(dpi)
(3) Mode 3: 720(dpi)×1440(dpi)
(4) Mode 4: 1440(dpi)×720(dpi)
(5) Mode 5: 2880(dpi)×1440(dpi)

Each mode is expressed by (printing resolution in the main scanning direction)×(printing resolution in the sub-scanning direction). For example, ‘Mode 3’ is expressed by the product of the printing resolution of 720 (dpi) in the main scanning direction and the printing resolution of 1440 (dpi) in the sub-scanning direction.

The mask setting module 82 sets a dither mask (dither matrix), which is applied to a series of processing executed by the halftoning module 86, corresponding to the print mode set by the print mode setting module 81. In the structure of this embodiment, a hard disk 88 stores two different dither masks, that is, a dither mask for Mode 2 and a dither mask for Mode 5. The reason for providing only the two dither masks against the five available print mode options and the method of setting the dither mask will be discussed later. The dither mask of this embodiment is equivalent to the threshold matrix of the invention.

The image data input module 83 inputs color image data from the application program.

The resolution conversion module 84 converts the resolution of the color image data (absolute resolution) processed by and input from the application program into a printing resolution processible by the printer driver 80 corresponding to the print mode set by the print mode setting module 81.

The color conversion module 85 refers to a color conversion table (not shown) stored in the hard disk 88 and converts the color tone data of the respective pixels constituting the input color image data into multi-tone data of respective colors, cyan (C), light cyan (LC), magenta (M), light magenta (LM), yellow (Y), and black (K) used by the printer PRT.

The halftoning module 86 applies the dither mask set by the mask setting module 82 to a halftoning process, which adopts the known dither method to express the tone values of image data by distributions of dots and thereby generate raster data.

The interlace data generation module 87 rearranges the raster data generated by the halftoning module 86 and sub-scan feed data in a preset format for transfer to the printer PRT, so as to generate print data, which is then supplied to the printer PRT.

The printer PRT may execute part of the above series of processing, instead of the printer driver 80.

The program for attaining the functions of the respective modules of the printer driver 80 is recorded in a computer readable recording medium. Typical examples of the recording medium include flexible disks, CD-ROMs, magneto-optical disks, IC cards, ROM cartridges, punched cards, prints with barcodes and other codes printed thereon, internal storage devices (memories, such as RAMs and ROMs) and external storage devices of the computer, and diversity of other computer readable media.

The printer PRT includes an input unit 91, a buffer 92, a main scan unit 93, a sub-scan unit 94, a head driving unit 95, and a drive timing table 96. The input unit 91 receives the print data transferred from the printer driver 80 and temporarily stores the received print data into the buffer 92. The main scan unit 93 and the sub-scan unit 94 make main scans of a print head and sub-scan feeds of printing paper according to the print data stored in the buffer 92. The head driving unit 95 refers to drive timings set in the drive timing table 96 to drive the print head and complete a printed image.

B. Print Data Generation Process

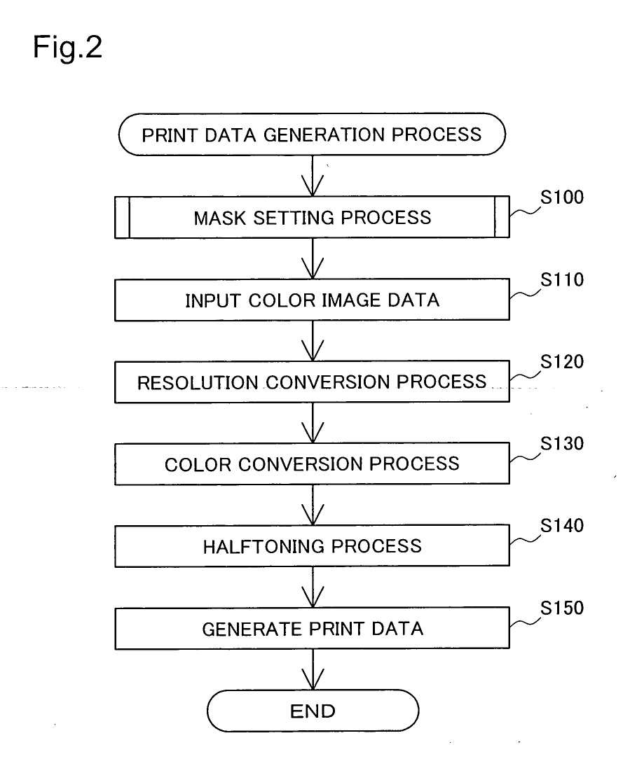

FIG. 2 is a flowchart showing a print data generation process, which is executed by the printer driver 80 in this embodiment.

The mask setting module 82 included in the printer driver 80 first executes a mask setting process (step S100), which sets a dither mask to be applied to the series of processing in the halftoning module 86 corresponding to the print mode set by the print mode setting module 81. The details of the mask setting process will be described later.

The image input module 83 in the printer driver 80 then inputs color image data from the application program (step S110). The resolution conversion module 84 converts the resolution of the input color image data corresponding to the print mode set by the print mode setting module 81 (step S120). The color conversion module 85 subsequently performs color conversion of the resolution-converted image data (step S130). The halftoning module 86 in the printer driver 80 then applies the dither mask set by the mask setting module 82 to the halftoning process and generate raster data from the color-converted image data (step S140). The interlace data generation module 87 rearranges the raster data and sub-scan feed data to generate print data (step S150), which is output to the printer PRT.

C. Mask Setting Process

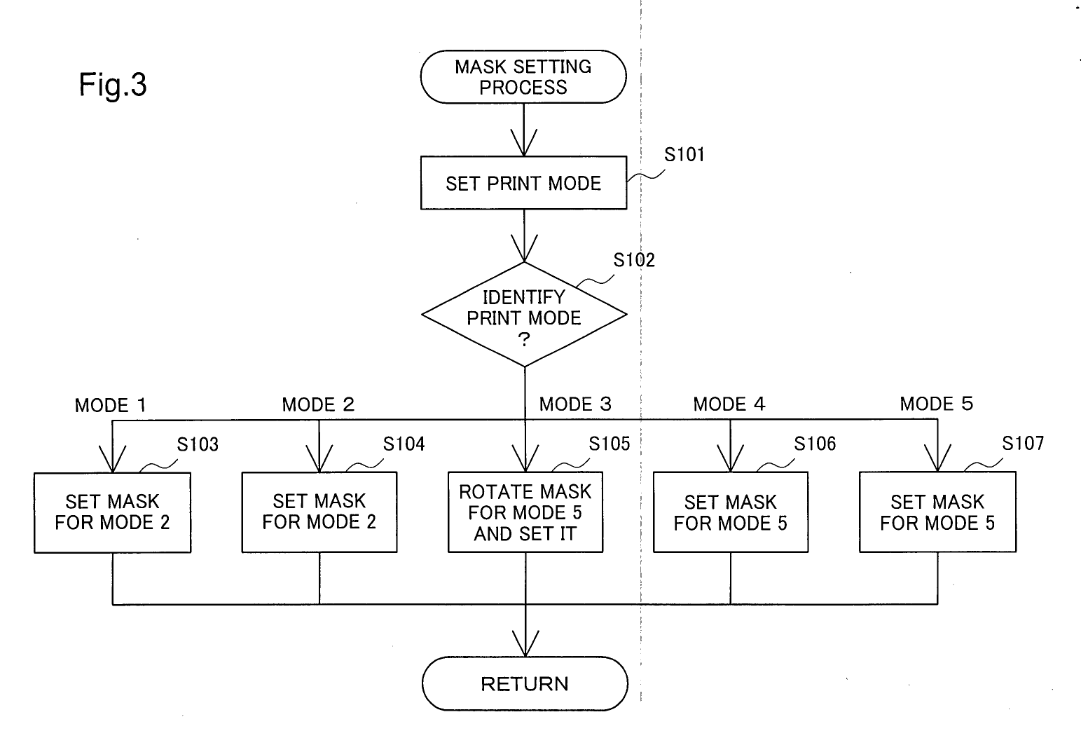

FIG. 3 is a flowchart showing the details of the mask setting process executed at step S100 in the print data generation process of FIG. 2.

The print mode setting module 81 included in the printer driver 80 sets a selected print mode (step S101). The mask setting module 82 in the printer driver 80 then identifies the print mode set by the print mode setting module 81 (step S102).

In response to the setting of ‘Mode 1’ to the print mode, the mask setting module 82 reads the dither mask for Mode 2 from the hard disk 88 and sets the dither mask for Mode 2 as a dither mask for Mode 1 in an internal memory (step S103). This setting is based on the inventors' experimental findings. In a system with two available print modes, it is assumed that the printing resolutions of a second print mode in the main scanning direction and in the sub-scanning direction are respectively n times (where n denotes a positive number) of the printing resolutions of a first print mode in the main scanning direction and in the sub-scanning direction. Application of a dither mask for the first print mode to generation of print data in the second print mode may lower the picture quality of a resulting printed image, whereas application of a dither mask for the second print mode to generation of print data in the first print mode does not lower the picture quality. In the structure of this embodiment, the printing resolutions of Mode 2 in the main scanning direction and in the sub-scanning direction are respectively twice of the printing resolutions of Mode 1 in the main scanning direction and in the sub-scanning direction. Namely the dither mask for Mode 2 is applicable to the setting of the print mode to ‘Mode 1’. This arrangement does not require individual preparation and storage of a dither mask for Mode 1 in the hard disk 88, and thus desirably saves the memory capacity of the hard disk 88 for storage of the dither masks.

In response to the setting of ‘Mode 2’ to the print mode, the mask setting module 82 reads the dither mask for Mode 2 from the hard disk 88 and sets the dither mask for Mode 2 in the internal memory (step S104).

In response to the setting of ‘Mode 3’ to the print mode, the mask setting module 82 reads the dither mask for Mode 5 from the hard disk 88, rotates the dither mask for Mode 5 clockwise by 90 degrees on the internal memory, and sets the rotated dither mask to a dither mask for Mode 3 in the internal memory (step S105). This setting is based on the inventors' experimental findings. In a system with two available print modes, it is assumed that a combination of the printing resolutions of a second print mode in the main scanning direction and in the sub-scanning direction is identical with an interchanged combination of the printing resolutions of a first print mode in the main scanning direction and in the sub-scanning direction. Application of a dither mask for the first print mode rotated clockwise by 90 degrees to generation of print data in the second print mode does not lower the picture quality of a resulting printed image. The printing resolutions of Mode 5 in the main scanning direction and in the sub-scanning direction are twice of the interchanged printing resolutions of Mode 3 in the main scanning direction and in the sub-scanning direction. The processing of step S105 is thus reasonable according to the inventors' experimental findings described here and described previously with regard to the setting of the dither mask in Mode 1. This arrangement does not require individual preparation and storage of a dither mask for Mode 3 in the hard disk 88, and thus desirably saves the memory capacity of the hard disk 88 for storage of the dither masks.

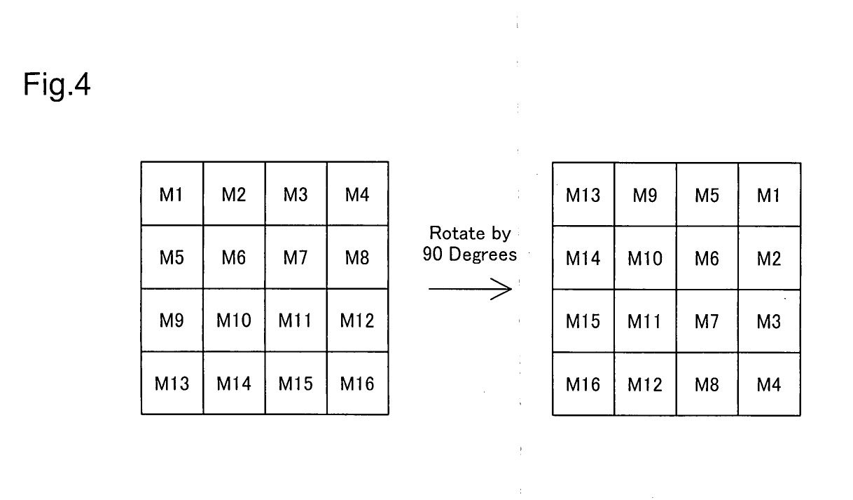

FIG. 4 shows clockwise rotation of a dither mask by 90 degrees. Although the print data generation process of the embodiment actually uses a 512×512 dither mask, the example of FIG. 4 shows a 4×4 dither mask for the simplicity of illustration and explanation. In the illustration of FIG. 4, M1 to M16 represent the respective elements of the 4×4 dither mask. The ‘clockwise rotation of the dither mask by 90 degrees’ rearranges the respective elements of the dither mask to the 90-degree-rotated positions. The procedure of this embodiment rotates the dither mask for Mode 5 clockwise by 90 degrees to set the dither mask for Mode 3. One possible modification may rotate the dither mask for Mode 5 counterclockwise by 90 degrees to set the dither mask for Mode 3.

In response to the identified setting of ‘Mode 4’ to the print mode at step S102, the mask setting module 82 reads the dither mask for Mode 5 from the hard disk 88 and sets the dither mask for Mode 5 as a dither mask for Mode 4 in the internal memory (step S106). In the structure of this embodiment, the printing resolutions of Mode 5 in the main scanning direction and in the sub-scanning direction are respectively twice of the printing resolutions of Mode 4 in the main scanning direction and in the sub-scanning direction. Because of the reason discussed above with regard to the setting of the dither mask in Mode 1, the dither mask for Mode 5 is applicable to the setting of the print mode to ‘Mode 4’.

In response to the setting of ‘Mode 5’ to the print mode, the mask setting module 82 reads the dither mask for Mode 5 from the hard disk 88 and sets the dither mask for Mode 5 in the internal memory (step S107).

As described above, the printing system of this embodiment sets the dither mask for Mode 2 as the dither mask for Mode 1 in response to the setting of ‘Mode 1’ to the print mode, while setting the dither mask for Mode 5 as the dither mask for Mode 4 in response to setting of ‘Mode 4’ to the print mode. In the case of setting the print mode to ‘Mode 3’, the printing system rotates the dither mask for Mode 5 clockwise by 90 degrees and sets the rotated dither mask to the dither mask for Mode 3. Only the two dither masks are thus sufficiently applicable to the five available print mode options, Mode 1 to Mode 5. This arrangement desirably saves the memory capacity of the hard disk 88 for storage of the dither masks.

D. Modifications

The embodiment discussed above is to be considered in all aspects as illustrative and not restrictive. There may be many modifications, changes, and alterations without departing from the scope or spirit of the main characteristics of the present invention. Some examples of possible modification are given below.

D1. Modified Example 1

The mask setting process of the embodiment shown in the flowchart of FIG. 3 rotates the dither mask for Mode 5 clockwise by 90 degrees to set the dither mask for Mode 3 in the case of setting the print mode to ‘Mode 3’. This rotation is, however, not essential for setting the dither mask for Mode 3. One possible modification may interchange the row elements with the column elements in the dither mask for Mode 5 to set the dither mask for Mode 3.

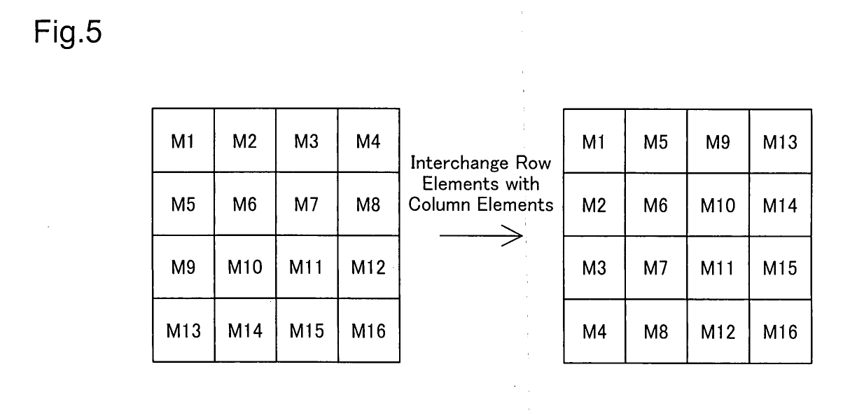

FIG. 5 shows interchange of row elements with column elements in a dither mask. Like the example of FIG. 4, the example of FIG. 5 shows a 4×4 dither mask for the simplicity of illustration and explanation. A dither mask after interchange of the row elements with the column elements is a transposed matrix of the original dither mask. This arrangement desirably generates print data in the print mode set to ‘Mode 3’ without lowering the picture quality of a resulting printed image.

D2. Modified Example 2

In the structure of the above embodiment, in response to the setting of ‘Mode 3’ to the print mode, the mask setting module 82 reads the dither mask for Mode 5 from the hard disk 88, rotates the dither mask for Mode 5 clockwise by 90 degrees on the internal memory, and sets the rotated dither mask to the dither mask for Mode 3 in the internal memory. This procedure of setting the dither mask for Mode 3 is, however, not restrictive at all. One modified procedure may set the dither mask for Mode 3 by changing the reading order of the respective elements of the dither mask for Mode 5 from the hard disk 88 or by changing the writing order of the respective elements of the dither mask for Mode 5 into the internal memory.

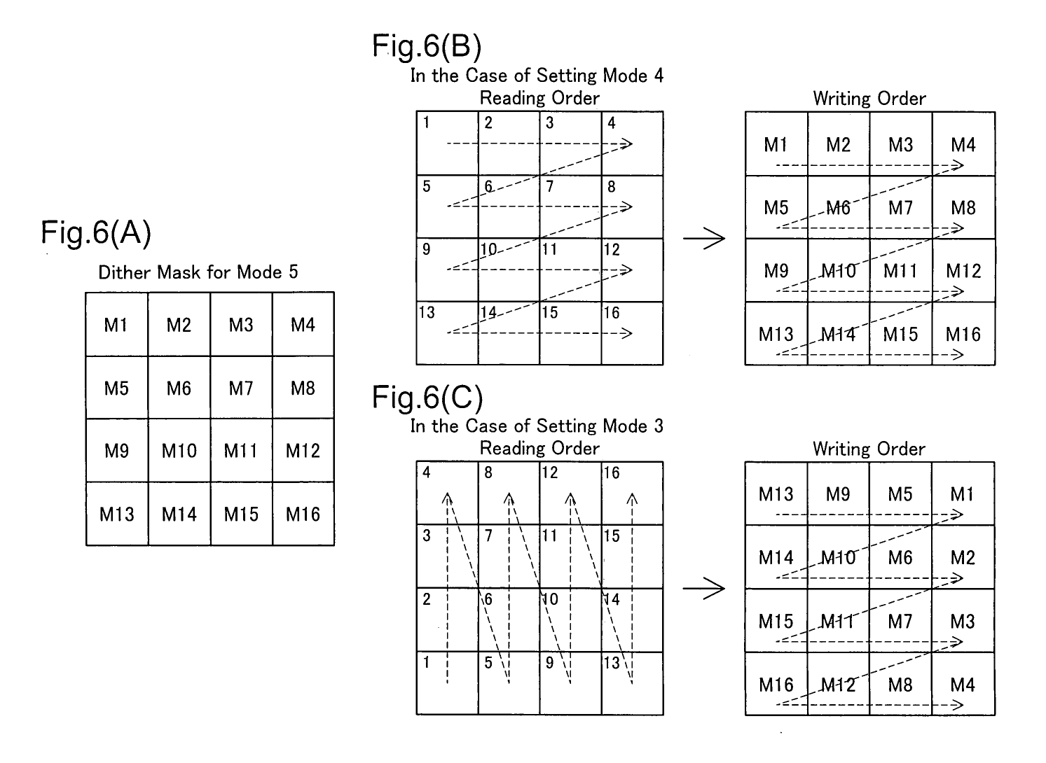

FIGS. 6(A) through 6(C) show preparation of dither masks for Mode 4 and Mode 3 from a dither mask for Mode 5 by changing the reading order of the respective elements of the dither mask for Mode 5 from the hard disk 88. Like the examples of FIG. 4 and FIG. 5, the example of FIG. 6 shows a 4×4 dither mask for the simplicity of illustration and explanation. FIG. 6(A) shows a dither mask for Mode 5.

In the case of setting the print mode to ‘Mode 4’, the procedure reads the respective elements of the dither mask for Mode 5 from the hard disk 88 in the numerical order of 1 to 16, that is, in the order from the upper left to the lower right as shown by the broken arrows in the left drawing of FIG. 6(B). The procedure then writes the respective elements into the internal memory in the order from the upper left to the lower right as shown by the broken arrows in the right drawing of FIG. 6(B). In the case of setting the print mode to ‘Mode 3’, on the other hand, the procedure reads the respective elements of the dither mask for Mode 5 from the hard disk 88 in the numerical order of 1 to 16, that is, in the order from the lower left to the upper right as shown by the broken arrows in the left drawing of FIG. 6(C). The procedure then writes the respective elements into the internal memory in the order from the upper left to the lower right as shown by the broken arrows in the right drawing of FIG. 6(C). This procedure can prepare the dither masks for Mode 3 and Mode 4 from the dither mask for Mode 5.

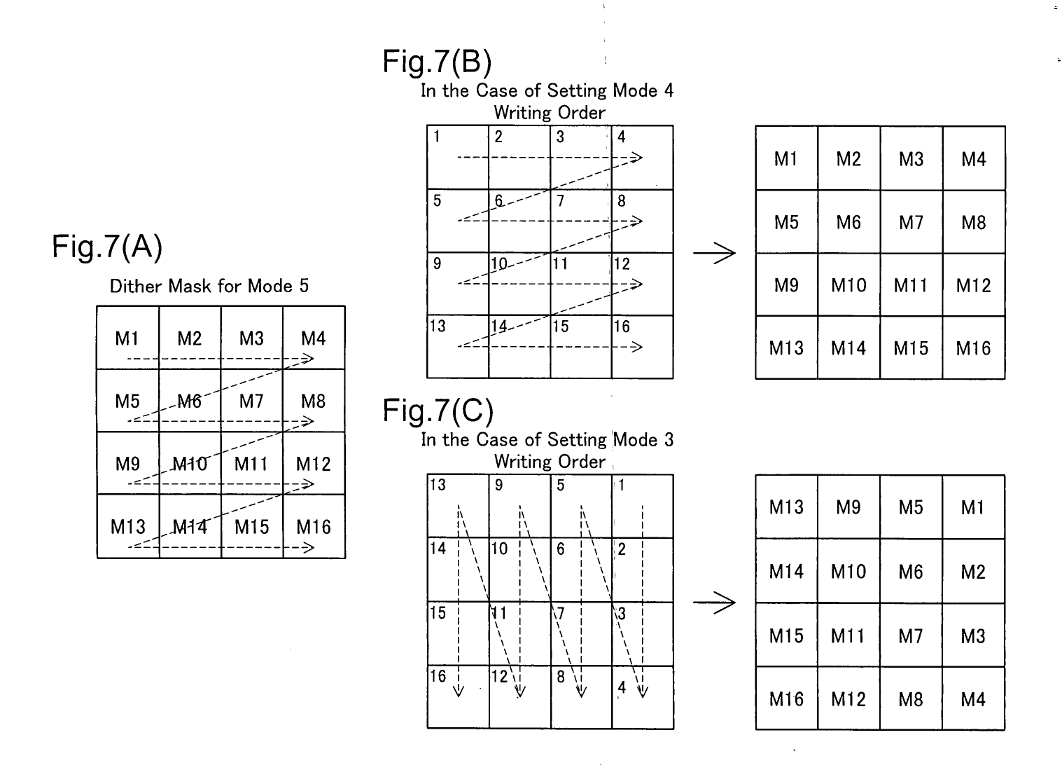

FIGS. 7(A) through 7(C) show preparation of dither masks for Mode 4 and Mode 3 from the dither mask for Mode 5 by changing the writing order of the respective elements of the dither mask for Mode 5 into the internal memory. Like the examples of FIG. 4 and FIG. 5, the example of FIG. 7 shows a 4×4 dither mask for the simplicity of illustration and explanation. FIG. 7(A) shows a dither mask for Mode 5.

The procedure reads the respective elements of the dither mask for Mode 5 from the hard disk 88 in the order from the upper left to the lower right as shown by the broken arrows in FIG. 7(A). In the case of setting the print mode to ‘Mode 4’, the procedure writes the respective elements of the dither mask for Mode 5 into the internal memory in the numerical order of 1 to 16, that is, in the order from the upper left to the lower right as shown by the broken arrows in the left drawing of FIG. 7(B). In the case of setting the print mode to ‘Mode 3’, on the other hand, the procedure writes the respective elements of the dither mask for Mode 5 into the internal memory in the numerical order of 1 to 16, that is, in the order from the upper right to the lower left as shown by the broken arrows in the left drawing of FIG. 7(C). This procedure can also prepare the dither masks for Mode 3 and Mode 4 from the dither mask for Mode 5.

D3. Modified Example 3

In the printing system of the embodiment, the printer driver 80 applies the dither matrices to the halftoning process by the dither method in any of the available print modes. Similar effects are given by application of dot pattern matrices to the density pattern method and application of diffusion coefficient matrices to the error diffusion method.

What is claimed is:

1. An image processing device that makes image data go through a preset series of image processing to generate processed data, which is to be supplied to a printing device that creates dots and completes a printed image,
where the printing device prints an image in a selected print mode between two available print modes, that is, a first print mode having a ratio of a printing resolution in a main scanning direction to a printing resolution in a sub-scanning direction equal to A to B, where A and B are mutually different natural numbers, and a second print mode having a ratio of the printing resolution in the main scanning direction to the printing resolution in the sub-scanning direction equal to B to A,
the image processing device comprising:
a storage module that stores a first threshold matrix prepared for the first print mode;
an image data input module that inputs object image data;
a print mode setting module that sets either one of the first print mode and the second print mode in response to a user's selection;
a resolution conversion module that converts an absolute resolution of the input object image data into a printing resolution corresponding to the set print mode;
a threshold matrix transform module that, in response to setting of the second print mode, reads the first threshold matrix from the storage module and generates a second threshold matrix for the second print mode from the first threshold matrix; and
a dot data generation module that generates dot data representing dot on-off state of respective pixels included in the resolution-converted image data, based on the resolution-converted image data and the threshold matrix corresponding to the set print mode.

2. An image processing device in accordance with claim 1, wherein the second threshold matrix is generated by rearranging respective elements of the first threshold matrix to 90-degree-rotated positions.

3. An image processing device in accordance with claim 1, wherein the second threshold matrix is a transposed matrix of the first threshold matrix.

4. An image processing device in accordance with claim 1, wherein the threshold matrix transform module changes a reading order of respective elements of the first threshold matrix from the storage module to generate the second threshold matrix.

5. An image processing device in accordance with claim 1, the image processing device having a working area used for generation of the second threshold matrix,
wherein the threshold matrix transform module reads the first threshold matrix from the storage module, writes the first threshold matrix in the working area, and processes the first threshold matrix by a preset operation on the working area, so as to generate the second threshold matrix.

6. An image processing device in accordance with claim 1, the image processing device having a working area used for generation of the second threshold matrix,
wherein the threshold matrix transform module reads the first threshold matrix from the storage module, and changes a writing order of respective elements of the first threshold matrix into the working area, so as to generate the second threshold matrix.

7. An image processing device that makes image data go through a preset series of image processing to generate processed data, which is to be supplied to a printing device that creates dots and completes a printed image,
where the printing device prints an image in a selected print mode between two available print modes, that is, a first print mode having a printing resolution in a main scanning direction and a printing resolution in a sub-scanning direction respectively equal to A and B, where A and B are mutually different natural numbers, and a second print mode having the printing resolution in the main scanning direction and the printing resolution in the sub-scanning direction respectively equal to n·A and n·B, where n denotes a positive number,
the image processing device comprising:
a storage module that stores a threshold matrix prepared for the second print mode;
an image data input module that inputs object image data;
a print mode setting module that sets either one of the first print mode and the second print mode in response to a user's selection;
a resolution conversion module that converts an absolute resolution of the input object image data into a printing resolution corresponding to the set print mode; and
a dot data generation module that, in response to setting of the first print mode, generates dot data representing dot on-off state of respective pixels included in the resolution-converted image data, based on the resolution-converted image data and the threshold matrix.

8. A control method of an image processing device that makes image data go through a preset series of image processing to generate processed data, which is to be supplied to a printing device that creates dots and completes a printed image,
where the printing device prints an image in a selected print mode between two available print modes, that is, a first print mode having a ratio of a printing resolution in a main scanning direction to a printing resolution in a sub-scanning direction equal to A to B, where A and B are mutually different natural numbers, and a second print mode having a ratio of the printing resolution in the main scanning direction to the printing resolution in the sub-scanning direction equal to B to A,
the control method comprising the steps of
(a) storing a first threshold matrix prepared for the first print mode in a preset storage module;
(b) inputting object image data;
(c) settings either one of the first print mode and the second print mode in response to a user's selection;
(d) converting an absolute resolution of the input object image data into a printing resolution corresponding to the set print mode;
(e) in response to setting of the second print mode, reading the first threshold matrix from the storage module and generating a second threshold matrix for the second print mode from the first threshold matrix; and
(f) generating dot data representing dot on-off state of respective pixels included in the resolution-converted image data, based on the resolution-converted image data and the threshold matrix corresponding to the set print mode.

9. A control method of an image processing device that makes-image data go through a preset series of image processing to generate processed data, which is to be supplied to a printing device that creates dots and completes a printed image,
where the printing device prints an image in a selected print mode between two available print modes, that is, a first print mode having a printing resolution in a main scanning direction and a printing resolution in a sub-scanning direction respectively equal to A and B, where A and B are mutually different natural numbers, and a second print mode having the printing resolution in the main scanning direction and the printing resolution in the sub-scanning direction respectively equal to n·A and n·B, where n denotes a positive number,
the control method comprising the steps of
(a) storing a threshold matrix prepared for the second print mode into a preset storage module;
(b) inputting object image data;
(c) setting either one of the first print mode and the second print mode in response to a user's selection;
(d) converting an absolute resolution of the input object image data into a printing resolution corresponding to the set print mode; and
(e) in response to setting of the first print mode, generating dot data representing dot on-off state of respective pixels included in the resolution-converted image data, based on the resolution-converted image data and the threshold matrix.

10. A computer program product for controlling an image processing device that makes image data go through a preset series of image processing to generate processed data, which is to be supplied to a printing device that creates dots and completes a printed image,
where the printing device prints an image in a selected print mode between two available print modes, that is, a first print mode having a ratio of a printing resolution in a main scanning direction to a printing resolution in a sub-scanning direction equal to A to B, where A and B are mutually different natural numbers, and a second print mode having a ratio of the printing resolution in the main scanning direction to the printing resolution in the sub-scanning direction equal to B to A,
the computer program product comprising:
a first program code of storing a first threshold matrix prepared for the first print mode in a preset storage module;
a second program code of inputting object image data;
a third program code of settings either one of the first print mode and the second print mode in response to a user's selection;
a fourth program code of converting an absolute resolution of the input object image data into a printing resolution corresponding to the set print mode;
a fifth program code of, in response to setting of the second print mode, reading the first threshold matrix from the storage module and generating a second threshold matrix for the second print mode from the first threshold matrix;
a sixth program code of generating dot data representing dot on-off state of respective pixels included in the resolution-converted image data, based on the resolution-converted image data and the threshold matrix corresponding to the set print mode; and
a computer readable medium for storing the first to sixth program codes.

11. A computer program product for controlling an image processing device that makes image data go through a preset series of image processing to generate processed data, which is to be supplied to a printing device that creates dots and completes a printed image,
where the printing device prints an image in a selected print mode between two available print modes, that is, a first print mode having a printing resolution in a main scanning direction and a printing resolution in a sub-scanning direction respectively equal to A and B, where A and B are mutually different natural numbers, and a second print mode having the printing resolution in the main scanning direction and the printing resolution in the sub-scanning direction respectively equal to n·A and n·B, where n denotes a positive number,
the computer program product comprising:
a first program code of storing a threshold matrix prepared for the second print mode into a preset storage module;
a second program code of inputting object image data;
a third program code of setting either one of the first print mode and the second print mode in response to a user's selection;
a fourth program code of converting an absolute resolution of the input object image data into a printing resolution corresponding to the set print mode;
a fifth program code of, in response to setting of the first print mode, generating dot data representing dot on-off state of respective pixels included in the resolution-converted image data, based on the resolution-converted image data and the threshold matrix; and
a computer readable medium for storing the first to sixth program codes.
